(19) United States
(12) Patent Application Publication
(10) Pub. No.: US 2008/0092208 A1
(43) Pub. Date: Apr. 17, 2008

(54) Method of recording the system login file and the recording device thereof

(76) Inventors: Shien-Jy Lee, Pingtung Hsien (TW); Yu-Cheng Chao, Kaohsiung (TW)

Correspondence Address: Hershkovitz & Associates, LLC, 2845 Duke Street, Alexandria, VA, 22314, US

(21) Appl. No.: 11/581,379

(22) Filed: Oct. 17, 2006

(51) Int. Cl. H04L 9/32

(52) U.S. Cl. 726/2

(57) ABSTRACT

A method of recording the system login file is implemented on a computer host connected to a network. Using the combination of software and hardware, a write program is installed in the computer host. The disclosed recording device is then connected to the computer host. After the connection, the write program writes the login file produced by the computer operating system (OS) into the recording device in a way independent of the computer OS. For computer OS cannot detect the connection of the recording device. The write program is the only means for the computer host to communicate with the recording device. Therefore, the invention can effectively prevent hackers from using the resources or information provided by the computer OS to change the login data. Moreover, it is convenient for the purpose of future tracking.

### BACKGROUND OF THE INVENTION

1. Field of the Invention

The invention relates to the technique of storing network connection data and, in particular, to a recording device for recording the complete login file to prevent connection data from being changed.

2. Description of Related Art

When somebody wants to log into a computer host (e.g., a Linux machine), the host usually executes a verification procedure or generates some important information. Such information may be used for tracking in the future for the administrator to understand previous login record of the system. From the viewpoint of the host, the information is directly recorded in some file once it is generated. This file is called the login file. The contents of the login file include a recording time, a source IP address, a login name, and programs being executed. Besides, it also records the time and contents of the executed programs. Since the login file records in detail everything the system programs perform, it is likely to endanger the system if it is obtained by hackers. Therefore, the computer system only allows root to access the login file.

Reasons for the system administrator to access the login file include:

1. It helps solving errors in logging into the system.

Because the login file stores hardware messages detected when the operating system (OS) starts, the host hardware information can be learned from it. Therefore, when the system has any problem, the system administrator can check the login file for the host hardware information.

2. It helps solving network service problems.

After the system is installed or set with a new service package, it automatically records problems in executing the package, if any. Likewise, the system administrator can check the login file to find out where the errors occur.

3. It helps recording the login information.

When the system cannot establish a network connection, the system administrator can analyze the login file (e.g., the Apache login file) to understand when the network connection program fails and the last login username, password, and IP address. Another important point is that when the system is invaded and used to attack other computers, the login file can be used for clarification and tracking the invader. The following is a set of data extracted from the login file of a Linux computer:

Apr 10 00:47:47 (login time) hcserver sshd[17240]: input_userauth_request: illegal

>>user sato (login name)

>>Apr 10 00:47:47 hcserver sshd[17240]: Failed password for illegal user (illegal user)

>>sato from 125.52.133.xxx port 47863 ssh2

(login IP address)

>>Apr 10 00:47:47 hcserver sshd[17240]: Received disconnect from

>>125.52.13.3.xxx: 11: Bye Bye (end of this record)

According to the above description, the system administrator can use the login file to understand important information about what the system has executed for the reference of management and maintenance. However, the login file of the current compute system network connection cannot forbid hackers from modifying it. That is, suppose some hacker invades the computer host. Even though the system records his/her login data (including the IP address), the hacker can modify the login when logging out. The login file stored in the computer system is not correct and, therefore, loses its primary function of keeping login records.

### SUMMARY OF THE INVENTION

An objective of the invention is to provide an external recording device for storing the login file of the system and the recording method independent of the computer host OS. Once the login file generated by the computer host is sent to the disclosed recording device for storage, the computer host cannot recall, read or modify it. Therefore, hackers cannot arbitrarily modify any set of data in the login file. A true login data file is thus maintained.

To achieve the above-mentioned objective, the recording method comprises the following means.

The first step provides a recording device, which includes a controller, a memory unit connected in both ways to the controller, and two serial port computer connection interfaces connected to the controller. One of the serial port computer connection interfaces is set by the controller for one-way writing and used for the computer host whose login file needs to be saved to be plugged in.

The second step provides a write program, which is built in the computer host and communicates with the recording device connected to the computer host for writing the login file produced by it into the recording device.

The disclosed recording device is plugged to the computer host via one of the serial port computer connection interface (not plug-n-play). The OS of the computer host cannot detect the properties and contents of the recording device. Therefore, for the OS of the computer system, the recording device is an invisible device. Moreover, the recording device only communicates with the writing device installed on the computer host. Only one-way writing is allowed for the controller settings of the recording device and the serial port computer connection interface plugged to the computer host. Therefore, even if someone obtains useable resources or information from the computer host OS, he/she still cannot read the login file written into the recording device back into the computer host. As a result, the invention can effectively prevent hackers from invading the computer host and modifying/deleting the login file stored in the recording device.

### BRIEF DESCRIPTION OF THE DRAWINGS

FIG. 1 is a block diagram of a preferred embodiment of the invention connected to a computer host; and

FIG. 2 is a time-ordered plot showing the procedure of the disclosed controller read program and the computer host built-in write program.

### DETAILED DESCRIPTION OF THE PREFERRED EMBODIMENT

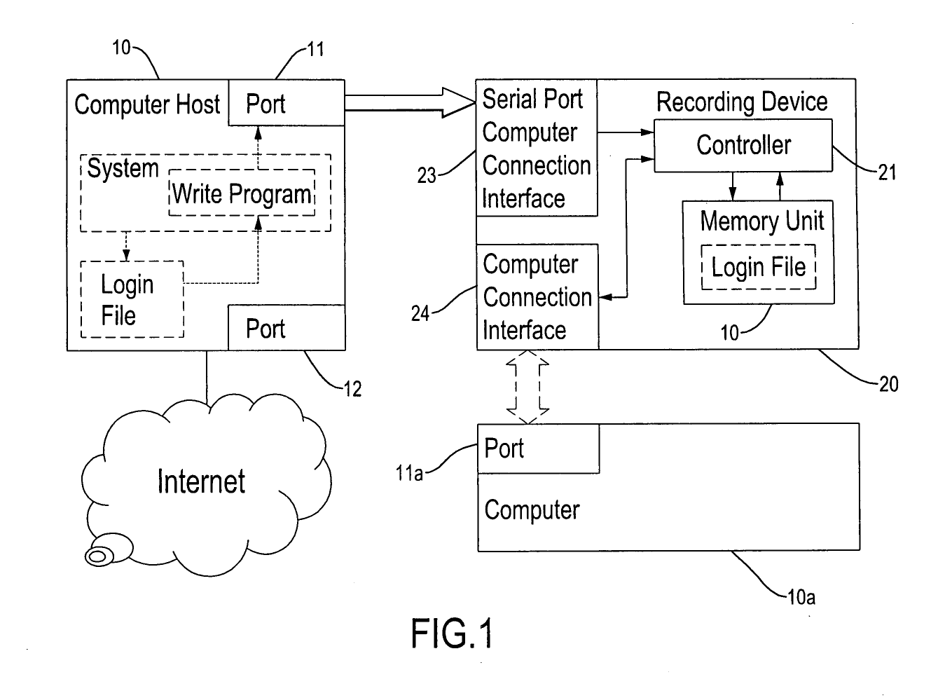

Please refer to FIG. 1 for the disclosed recording method. The method provides a recording device 20 comprising a controller 21, a memory unit 22 in dual connections with the controller 21, a serial port computer connection interface 23 in connection with the controller 21, and a computer connection interface 24 in connection with the controller 21. The serial port computer connection interface 23 can be an RS-232 interface. Since the serial port computer connection interface 23 is not a plug-n-play interface, the controller 21 sets it purely for writing and uses it for the connection with a computer host 10 that generates a login file.

The method also provides a write program, built in the computer host 10. It communicates with the recording device 20 plugged into the computer host 10, writing the login file produced by the computer host 10 into the recording device 20.

The above-mentioned recording device 20 of the invention is plugged into the computer host 10 via one of the one-way serial port computer connection interfaces 23. Since the serial port computer connection interface 23 is not a plug-n-play interface, the OS of the computer host 10 cannot detect the properties and contents of the recording device 20. Therefore, the recording device is an invisible device for the computer OS. Moreover, the recording device 20 only communicates with the write program in the computer host 10. The controller 21 of the recording device 20 sets the serial port computer connection interface 23 plugged into the computer host to be one-way writing. Once the login file produced by the computer host 10 is written into the recording device 20 by the write program, it is impossible for the login file written in the recording device to be read back into the computer host 10a using the resources or information provided by the computer OS. It is therefore unable for anyone to read or modify the login file. Consequently, the true login file can be safely kept in the disclosed recording device.

The other computer connection interface 24 in the disclosed recording device 20 is used for the connection with an ordinary computer 10a. The controller 20 sets the computer connection interface 24 to be used by the management memory unit 22. That is, when a user plugs the disclosed recording device 20 to a computer 10a, the controller 21 knows that the interface currently connected with the computer 10a is a read-only computer connection interface 24. Therefore, it only receives specific commands given by the computer 10a, such as reading data stored in the memory unit 22. Therefore, if the user wants to obtain data stored in the login file, he/she has to use this computer connection interface 24 to connect with the computer 10a in order to successfully read it out. As a result, the stored login data cannot be read out by the same computer host according to the invention.

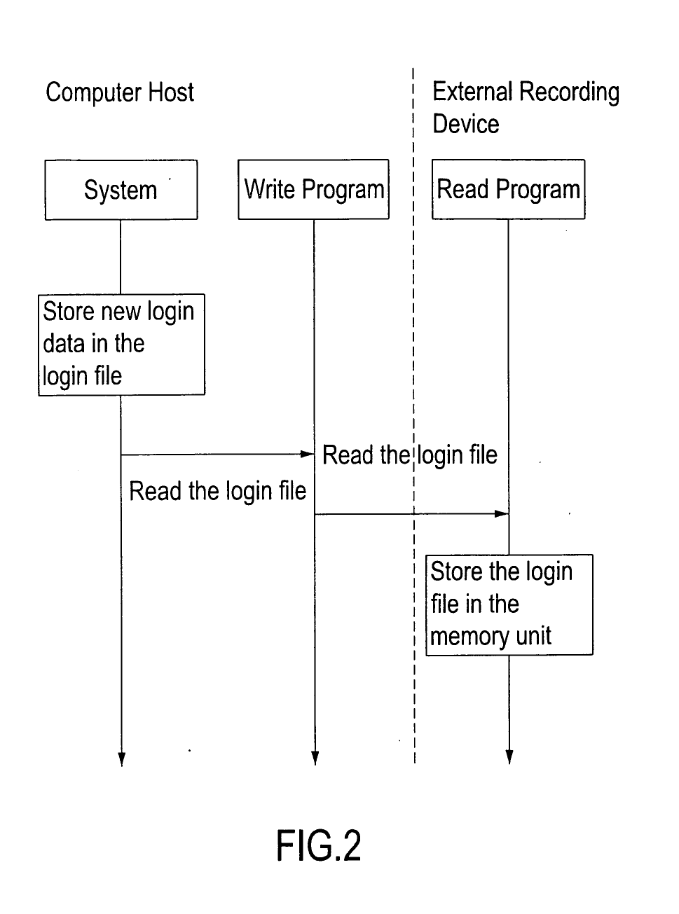

With reference to FIG. 2, the write program of the computer host 10 periodically writes the login file produced by the computer host 10 into the invention. The read program of the controller 21 periodically retrieves the login file from the computer host 10 in accord with its write program and stores it in the memory unit 22 of the invention. As the memory unit 22 has a limited capacity, the read program eventually covers all the stored login files stored in the memory unit 22 after a certain time. This time in principle is set according to the login file update time of the computer system 10. Therefore, there is not much change with respect to the habit of the system administrator. This is very convenient.

When some hacker logs into the computer host, the system automatically writes the hacker's login data (including login time, account name, password, and IP address) into the login file. Some experienced computer system hackers may modify the contents of the login file before logging out the system so that the system administrator cannot track the hacker by comparing the login file contents with the breakdown time of the system. In that case, it is impossible for the system administrator to find out the true login information of the hacker.

In accord with the above-mentioned external recording device with along the design of a write program, the login file stored in the invention cannot be read out and modified by the same computer. Each set of login data can therefore be faithfully recorded and stored. Therefore, the invention provides the system administrator with a login file backup. This enables the system administrator to analyze the true login data and avoid the problem that the login file of the computer host is modified by the hacker.

What is claimed is:

1. A recording method for a system login file, comprising the steps of:
providing a recording device, which includes a controller, a memory unit in dual connections with the controller, a serial port computer connection interface in connection with the controller, and a computer connection interface in connection with the controller; wherein one of the serial port computer connection interfaces is set by the controller to be one-way writing and for the connection with the computer host whose login file is to be recorded; and
providing a write program, which is built in the computer host that generates the login file, communicates with the recording device plugged into the computer host, and writes the login file produced by the computer host into the recording device.

2. The recording method as claimed in claim 1, wherein the write program periodically writes the system login file into the recording device.

3. The recording method as claimed in claim 1, wherein the login file contains data of other network devices logging into the computer host, including login account name, time, and IP address.

4. The recording method as claimed in claim 1, wherein the serial port computer connection port is an RS-232 computer connection interface.

5. The recording method as claimed in claim 2, wherein the serial port computer connection port is an RS-232 computer connection interface.

6. The recording method as claimed in claim 3, wherein the serial port computer connection port is an RS-232 computer connection interface.

7. A recording device for a system login file, comprising:
a controller;
a memory unit, which is in dual connections with the controller;
a serial port computer connection interface, which is electrically coupled to the controller and set by the controller as a one-way writing interface and connected to the same-type connection port of the computer host, allowing only writing in data and forbidding users to read or modify the data using the same interface; and
a computer connection interface, which is electrically coupled to the controller for the connection with the same-type connection port of the computer host;
wherein the controller receives a command sent by the connected computer host and reads out the data stored in the memory unit.

8. The recording device of claim 7, wherein the serial port computer connection port is an RS-232 computer connection interface.
